(19) United States
(12) Patent Application Publication
(10) Pub. No.: US 2014/0084506 A1
(43) Pub. Date: Mar. 27, 2014

(54) MOULDING METHOD

(71) Applicant: Ramchander Dorasamy, Durban (ZA)

(72) Inventor: Ramchander Dorasamy, Durban (ZA)

(21) Appl. No.: 14/115,526

(22) PCT Filed: Mar. 23, 2012
(86) PCT No.: PCT/ZA2012/000017

§ 371 Date: Nov. 4, 2013

(30) Foreign Application Priority Data
May 13, 2011 (ZA) 2011-03609

(51) Int. Cl. B29D 99/00; B29C 44/34

(52) U.S. Cl. CPC B29D 99/0064; B29C 44/355
USPC 264/54; 264/299; 264/328.1

(57) ABSTRACT

The invention provides for a method of manufacturing a hollow article, which includes the step of introducing a polymeric composition that is settable into an article that has a shape-retaining property and at the same time a degree of flexibility which is yet insufficient to cause distortion of the article on the application of normal force.

### TECHNICAL FIELD OF THE INVENTION

This invention relates to a method of moulding hollow articles and more specifically articles having a shell with an opening such as headgear, pots, and the like.

### BACKGROUND ART

The invention is particularly suited to the manufacture of helmets which are generally manufactured by injection moulding using thermoplastic material in order to produce strong, missile-proof articles for the mining and other industries, for police and army duties, as well as domestic and leisure activities in which case it is not only for protective purposes.

One of such activities is sport watching and, in particular cricket of the twenty-20 variety where sixes predominate in the play and which may cause injury to spectators. Such helmets are also used extensively for other sports such as rugby and one has only to watch TV live broadcasts to notice the large number of BULLS or SHARKS helmets at rugby games.

However, at rugby or soccer and other matches it not really necessary to have missile-proof properties—in fact, such helmets can be uncomfortable and it is one of the objects of the present invention to provide a helmet that can be of conventional shape and configuration and yet far more comfortable for the wearer.

### DISCLOSURE OF THE INVENTION

According to the invention a method of manufacturing a hollow article includes the step of introducing a polymeric composition that is settable into an article that has a shape-retaining property and at the same time a degree of flexibility which is yet insufficient to cause distortion of the article on the application of normal force.

In a preferred form of the invention the method involves injection moulding and the polymeric composition is chosen according to its property of setting into the desired flexible product. The composition may ideally also include a blowing agent, which imparts lightness to the final product.

The preferred polymer is ethylene vinyl acetate (EVA), in all its grades and shore-hardnesses.

The distance between the inner and outer elements of the mould is chosen having regard to the desired thickness of the article and, in the case of the use of a blowing agent the amount of composition used is predetermined according to the degree of expansion due to the blowing agent—or the desired degree of blowing required for the particular thickness.

It will be appreciated that the invention may be applied to the production of a number of articles such as flower or plant pots, kitchenware, ornaments and many others.

### BRIEF DESCRIPTION OF THE DRAWINGS

An embodiment of the invention is illustrated in the accompanying pictures, in which:

FIG. 1 is a drawing of a mould as used in the method of manufacture; and

FIG. 2 is a photograph of an example of a product produced using the method of manufacture.

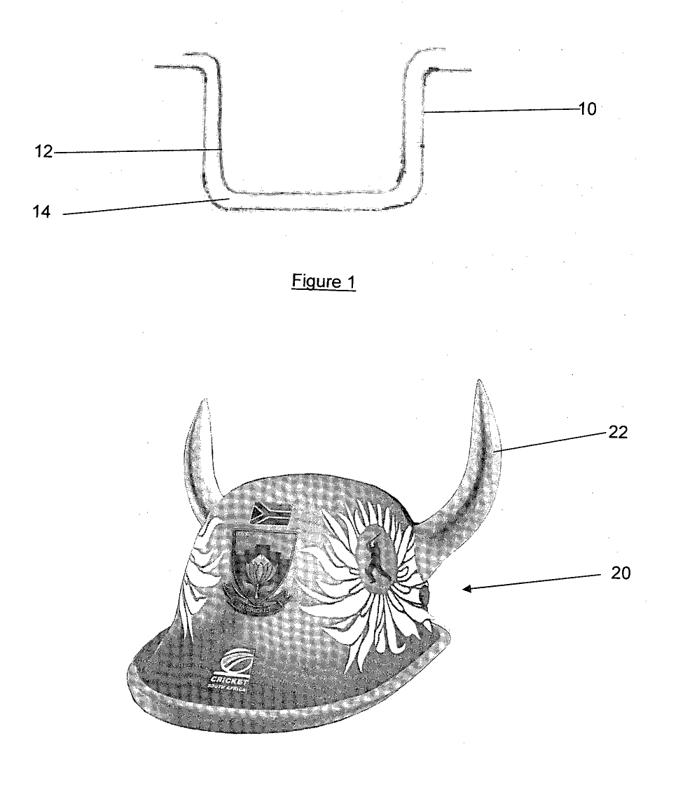

### DETAILED DESCRIPTION OF THE PREFERRED EMBODIMENT

In the sketch a mould is depicted with an outer element 10 and an inner element 12 spaced apart by a predetermined distance 14.

The polymeric composition is introduced in the usual manner and, as discussed above, its volume is predetermined in relation to the density of the wall of the produced article and also taking into consideration the degree of blowing expansion required.

A typical product of the invention is shown in FIG. 2. Despite having the appearance of a conventional helmet 20, it has a degree of flexibility that imparts comfort. In addition, the horns 22 are sufficiently flexible and deformable to prevent injury upon engagement with another person.

1. A method of manufacturing a hollow article characterized in that the method includes the step of introducing a settable polymeric composition into an article that has a shape-retaining property and at the same time a degree of flexibility which is yet insufficient to cause distortion of the article on the application of normal force.

2. The method of claim 1 characterized in that the polymeric composition is introduced by injection moulding.

3. The method of claim 1 characterized in that the polymeric composition is chosen according to its property of setting into the desired flexible product.

4. The method of claim 3 characterized in that the composition ideally includes a blowing agent, which imparts lightness to the final product.

5. The method of claim 1 characterized in that the polymer is ethylene vinyl acetate (EVA), in all its grades and shore-hardnesses.

6. The method of claim 1 characterized in that the distance between the inner and outer elements of the mould is chosen having regard to the desired thickness of the article.

7. The method of claim 4 characterized in that the amount of polymeric composition used is predetermined according to the degree of expansion due to the blowing agent.

8. The method of claim 4 characterized in that the amount of polymeric composition used is predetermined according to the desired degree of blowing required for the particular thickness.
